(19) United States
(12) Patent Application Publication
(10) Pub. No.: US 2025/0225242 A1
(43) Pub. Date: Jul. 10, 2025

(54) METHOD AND APPARATUS FOR BLOCKING MALICIOUS NON-PORTABLE EXECUTABLE FILES USING REVERSING ENGINE AND CDR ENGINE

(71) Applicant: SECULETTER CO., LTD., Gyeonggi-do (KR)

(72) Inventor: Seung Hwan YANG, Anyang-si (KR)

(73) Assignee: SECULETTER CO., LTD., Seongnam-si (KR)

(21) Appl. No.: 17/780,695

(22) PCT Filed: May 26, 2022
(86) PCT No.: PCT/KR2022/007477

§ 371 Date: May 27, 2022

(51) Int. Cl. G06F 21/56; G06F 8/74; G06F 21/57

(52) U.S. Cl. CPC G06F 21/568; G06F 8/74; G06F 21/577; G06F 2221/033

(57) ABSTRACT

This specification relates to a method of blocking a malicious non-portable executable (non-PE) file using a reversing engine and a contents disarm and reconstruction (CDR) engine. The method includes detecting at least one of vulnerability and content within an analysis target non-PE file by performing reversing analysis on the analysis target non-PE file and storing results of the detection, performing disarming on the content within the analysis target non-PE file and storing results of the disarming, generating results of the reading of a disarming file obtained by performing the disarming, based on the results of the detection and the results of the disarming, and blocking the disarming file based on the results of the reading.

### TECHNICAL FIELD

The present disclosure relates to a method and apparatus for blocking a malicious non-portable executable (non-PE) file, and more particularly, to a method and apparatus for blocking a malicious non-PE file using a reversing engine and a contents disarm and reconstruction (CDR) engine.

### BACKGROUND ART

In an advanced persistent threat (APT) attack, in order for an attacker to determine a specific target and steal targeted information, various types of malware are persistently used by applying a high-level attack scheme. In particular, an APT attack is not detected at an initial intrusion stage in many cases. A non-portable executable (non-PE) file including malware is chiefly more used in the APT attack than a portable executable (PE) file.

A non-PE file has a concept opposite to that of a PE file, and means a file that is not autonomously executed. Examples of the non-PE file may include document files such as an MS Word file, an Excel file, a Hangul file, and a PDF file, an image file, a moving image file, a JavaScript file, and an HTML file. The reason why a non-PE file including malware is a lot used for an APT attack is that an application program that executes the non-PE file basically has some degree of security vulnerability. Furthermore, if malware is included in the non-PE file, varietal malware can be easily generated by changing the non-PE file.

A document act is an action of a non-PE file to execute an action of a related application program. The existing APT solutions determine whether a non-PE file is malicious by monitoring a change in a sandbox (virtual machine (VM)) after an action of a document occurs because the APT solutions operate based on a document act. In this case, a long analysis time is required because whether the non-PE file is malicious is determined after a wait for the full revelation of the document act.

Furthermore, the existing APT solutions, such as CDR, have a security blank because the APT solutions can remove malicious active content, but cannot remove vulnerability occurring in an essential element (e.g., the body or a font) of a document.

### DISCLOSURE

### Technical Problem

Various embodiments are directed to providing a method and apparatus for blocking a malicious non-PE file using a reversing engine and a CDR engine.

Technical objects to be achieved by this specification are not limited to the aforementioned object, and the other objects not described above may be evidently understood from the following detailed description of the specification by a person having ordinary knowledge in the art to which this specification pertains.

### Technical Solution

In an embodiment, a method of blocking a malicious non-portable executable (non-PE) file using a reversing engine and a contents disarm and reconstruction (CDR) engine includes detecting at least one of vulnerability and content within an analysis target non-PE file by performing reversing analysis on the analysis target non-PE file and storing results of the detection, performing disarming on the content within the analysis target non-PE file and storing results of the disarming, generating results of the reading of a disarming file obtained by performing the disarming, based on the results of the detection and the results of the disarming, and blocking the disarming file based on the results of the reading.

In another embodiment, an apparatus for blocking a malicious non-portable executable (non-PE) file using a reversing engine and a contents disarm and reconstruction (CDR) engine includes a communication unit, a memory comprising the reversing engine and the CDR engine, a processor configured to functionally control the communication unit and the memory, configured to detect at least one of vulnerability and content within an analysis target non-PE file by performing reversing analysis on the analysis target non-PE file and store results of the detection by using the reversing engine, and configured to perform disarming on the content within the analysis target non-PE file and store results of the disarming by using the CDR engine, and a result reading unit configured to generate results of the reading of a disarming file obtained by performing the disarming, based on the results of the detection and the results of the disarming, and block the disarming file based on the results of the reading.

Detailed contents of other embodiments are included in the detailed description and the drawings.

### Advantageous Effects

According to an embodiment of the present disclosure, a security blank which may occur when only the CDR engine is used can be supplemented by using the reversing engine and the CDR engine.

Effects which may be obtained in this specification are not limited to the aforementioned effects, and other effects not described above may be evidently understood by a person having ordinary knowledge in the art to which this specification pertains from the following description.

### BRIEF DESCRIPTION OF DRAWINGS

FIG. 1 is a block diagram illustrating a construction of an electronic device which is related to the present disclosure.

FIG. 2 is a block diagram illustrating a construction of an apparatus for blocking a malicious non-PE file according to an embodiment of the present disclosure.

FIG. 3 is a diagram exemplifying a normal input and an abnormal input which may be applied to an embodiment of the present disclosure.

FIG. 4 is a diagram exemplifying a flow of the execution of an application program when a normal value is input and a flow of the execution of an application program when an abnormal value is input.

FIG. 5 is a flowchart exemplifying a method of determining a document act which may be applied to an embodiment of the present disclosure.

FIG. 6 is a flowchart exemplifying a method of blocking a non-PE file which may be applied to an embodiment of the present disclosure.

FIG. 7 is a flowchart specifically illustrating step S6100 of storing the results of detection in FIG. 6.

FIG. 8 is a diagram illustrating an example of the results of detection by a reversing engine.

FIG. 9 is a diagram illustrating another example of the results of detection by the reversing engine.

FIG. 10 is a flowchart specifically illustrating step S6200 of storing the results of disarming in FIG. 6.

FIG. 11 is a diagram illustrating an example of the results of disarming by a CDR engine.

FIG. 12 is a diagram illustrating another example of the results of disarming by the CDR engine.

FIG. 13 is a flowchart specifically illustrating step S6300 of generating the results of reading in FIG. 6.

FIG. 14 is a diagram exemplifying a reading result screen displayed through a terminal.

### MODE FOR INVENTION

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Terms used in this specification are used to describe embodiments and are not intended to limit the present disclosure. In this specification, an expression of the singular number includes an expression of the plural number unless clearly defined otherwise in an introduction sentence. The term “comprises” and/or “comprising” used in this specification does not exclude the presence or addition of one or more other elements in addition to a mentioned element.

Hereinafter, embodiments disclosed in this specification are described in detail with reference to the accompanying drawings. The same or similar element is assigned the same reference numeral regardless of its reference numeral, and a redundant description thereof is omitted.

It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various elements, but the elements are not restricted by the terms. The terms are used to only distinguish one element from the other element.

When it is said that one element is “connected” or “coupled” to another element, it should be understood that one element may be directly connected or coupled to another element, but a third element may exist between the two elements. In contrast, when it is described that one element is “directly connected to” or “brought into direct contact with” the other element, it should be understood that a third element does not exist between the two elements.

An expression of the singular number includes an expression of the plural number unless clearly defined otherwise in the context.

In this specification, it is to be understood that a term, such as “include” or “have”, is intended to designate that a characteristic, a number, a step, an operation, an element, a part or a combination of them described in the specification is present, and does not exclude the presence or addition possibility of one or more other characteristics, numbers, steps, operations, elements, parts, or combinations of them in advance.

Furthermore, the term “ . . . unit” used in this specification means a software or hardware element, and the “ . . . unit” performs specific tasks. However, the term “. . . unit” does not mean that it is limited to software or hardware. The “ . . . unit” may be configured to reside on an addressable storage medium and configured to operate one or more processors. Accordingly, examples of the “ . . . unit” may include elements, such as software elements, object-oriented software elements, class elements, and task elements, processes, functions, attributes, procedures, sub-routines, segments of a program code, drivers, firmware, a microcode, circuitry, data, a database, data structures, tables, arrays, and variables. The functionalities provided in the elements and the “ . . . units” may be combined into fewer elements and “ . . . units”, or may be further separated into additional elements and “. . . units”.

Furthermore, according to an embodiment of this specification, “ . . . unit” may be implemented as a processor and a memory. The term “processor” should be widely interpreted as including a general-purpose processor, a central processing device (CPU), a microprocessor, a digital signal processor (DSP), a controller, a microcontroller, a state machine, etc. In some environments, the “processor” may denote an application-specific semiconductor (ASIC), a programmable logic device (PLD), a field programmable gate array (FPGA), etc. The term “processor” may denote a combination of processing devices, such as a combination of a DSP and a microprocessor, a combination of a plurality of microprocessors, a combination of one or more microprocessors combined with a DSP core, or a combination of any other such elements.

The term “memory” should be widely interpreted as including any electronic component capable of storing electronic information. The term “memory” may denote various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, a magnetic or optical data storage device, and registers. If a processor can read information from memory and/or record information on the memory, the memory is said to be in the state in which the memory electronically communicates with the processor. The memory integrated on the processor may be in the electronic communication state with the processor.

A “non-PE file” used in this specification has a concept opposite to that of a PE file or an executable file, and means a file that is not autonomously executed. For example, the non-PE file may be a document file such as a PDF file, a Hangul file, or an MS Word file, an image file such as a JPG file, a video file, a JavaScript file, or an HTML file, but the present disclosure is not limited thereto.

Hereinafter, embodiments are described in detail with reference to the accompanying drawings in order for a person having ordinary knowledge in the art to which this specification pertains to easily carry out the embodiments. Furthermore, in order to clearly describe the present disclosure, parts not related to the description may be omitted in the drawings.

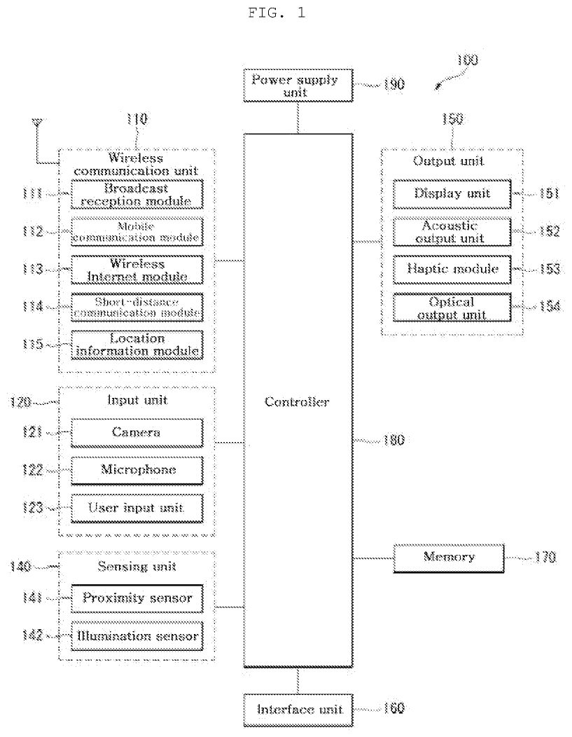

FIG. 1 is a block diagram for describing a construction of an electronic device related to an embodiment of the present disclosure.

An electronic device 100 may include a wireless communication unit 110, an input unit 120, a sensing unit 140, an output unit 150, an interface unit 160, a memory 170, a controller 180, a power supply unit 190, etc. The elements illustrated in FIG. 1 are not essential for implementing the electronic device 100. The electronic device 100 described in this specification may include more or less elements than the listed elements.

More specifically, among the elements, the wireless communication unit 110 may include one or more modules which enable wireless communication between the electronic device 100 and a wireless communication system, between the electronic device 100 and another electronic device 100, or between the electronic device 100 and an external server. Furthermore, the wireless communication unit 110 may include one or more modules that connect the electronic device 100 to one or more networks.

The wireless communication unit 110 may include at least one of a broadcast reception module 111, a mobile communication module 112, a wireless Internet module 113, a short-distance communication module 114, and a location information module 115.

The input unit 120 may include a camera 121 or an image input unit for receiving an image signal, a microphone 122 or an audio input unit for receiving an audio signal, and a user input unit 123 for receiving information from a user. Examples of the input unit 120 may include a touch key and a push key (or mechanical key). Voice data or image data collected by the input unit 120 may be analyzed and processed as a control command of a user.

The sensing unit 140 may include one or more sensors for sensing at least one of information within the electronic device 100, information about a surrounding environment that surrounds the electronic device 100, and user information. For example, the sensing unit 140 may include at least one of a proximity sensor 141, an illumination sensor 142, a touch sensor, an acceleration sensor, a magnetic sensor, a gravity (G)-sensor, a gyroscope sensor, a motion sensor, an RGB sensor, an infrared (IR) sensor, a finger scan sensor, an ultrasonic sensor, an optical sensor (e.g., the camera 121), a battery gauge, an environment sensor (e.g., a barometer, a soil hygrometer, a thermometer, a radioactivity detection sensor, a heat detection sensor, or a gas detection sensor), a chemical sensor (e.g., an electronic nose, a healthcare sensor, or a bio recognition sensor). The electronic device 100 disclosed in this specification may combine and use pieces of information sensed by at least two of the sensors.

The output unit 150 is for generating an output that is related to a visual sense, an auditory sense, or a tactile sense. The output unit 150 may include at least one of a display unit 151, an acoustic output unit 152, a haptic module 153, and an optical output unit 154. The display unit 151 may implement a touch screen by forming a mutual layer structure with a touch sensor or by being formed along with the touch sensor in an integrated way. The touch screen may function as the user input unit 123 that provides an input interface between the electronic device 100 and a user, and may also provide an output interface between the electronic device 100 and a user.

The interface unit 160 plays a role as a passage with various types of external devices that are connected to the electronic device 100. The interface unit 160 may include at least one of a wired/wireless headset port, an external charger port, a wired/wireless data port, a memory card port, a port that connects a device having an identification module, an audio input/output (I/O) port, a video I/O port, and an earphone port. The electronic device 100 may perform proper control that is related to an external device connected thereto, based on the external device being connected to the interface unit 160.

Furthermore, the memory 170 stores data that supports various functions of the electronic device 100. The memory 170 may store multiple application programs (or applications) that are driven in the electronic device 100, data for an operation of the electronic device 100, and instructions. At least some of such application programs may be downloaded from an external server through wireless communication. Furthermore, at least some of the application programs may be present in the electronic device 100 from the time of release for basic functions (e.g., incoming, outgoing, receiving messages, and outgoing functions) of the electronic device 100. The application program may be stored in the memory 170, may be installed in the electronic device 100, and may be driven to perform an operation or function of the electronic device by the controller 180.

The controller 180 commonly controls an overall operation of the electronic device 100 in addition to an operation related to the application program. The controller 180 may provide or process information or a function suitable for a user by processing a signal, data, or information that is input or output through the aforementioned elements or driving the application program stored in the memory 170.

Furthermore, the controller 180 may control at least some of the elements described with reference to FIG. 1 in order to drive the application program stored in the memory 170. Moreover, the controller 180 may combine and operate at least two of the elements included in the electronic device 100 for the driving of the application program.

The power supply unit 190 is supplied with external power and internal power and supplies power to each of the elements included in the electronic device 100, under the control of the controller 180. The power supply unit 190 includes a battery. The battery may be an embedded battery or a battery having a replaceable form.

At least some of the elements may cooperate with each other and operate in order to implement an operation, control, or a control method of the electronic device 100 according to various embodiments that are described below. Furthermore, an operation, control, or a control method of the electronic device 100 may be implemented in the electronic device 100 by the driving of at least one application program stored in the memory 170.

In an embodiment of the present disclosure, a server (or a cloud server) may include the electronic device 100. The electronic device 100 may be collectively called a terminal. The terminal may be connected to an external server (or an external cloud server) over a network, and may communicate therewith.

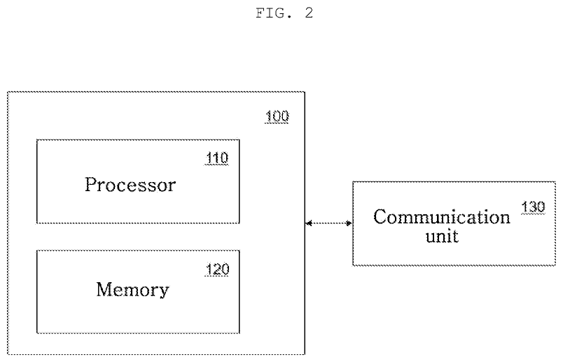

FIG. 2 is a block diagram illustrating a construction of an apparatus for blocking a malicious non-PE file according to an embodiment of the present disclosure. Hereinafter, for convenience of description, the apparatus for blocking a malicious non-PE file is called a “server.”

Referring to FIG. 2, a server 200 may include a controller 210, a result reading unit 220, and a communication unit 230. The controller 210 may include a processor 212 and a memory 214. The processor 212 may perform instructions stored in the memory 214. The processor 212 may control the communication unit 230. The memory 214 may include a cache memory. The cache memory may temporarily store an original document described later for a given time.

The processor 212 may control an operation of the server 200 based on an instruction stored in the memory 220. The server 200 may include one processor or may include a plurality of processors. If the server 200 includes a plurality of processors, at least some of the plurality of processors may be disposed at physically spaced distances. Furthermore, the server 200 is not limited thereto, and may be implemented in various known manners.

The communication unit 230 may include one or more modules that enable wireless communication between the server and a wireless communication system, between the server and another server, or between the server and an external server (or terminal). Furthermore, the communication unit 230 may include one or more modules that connect the server to one or more networks.

The controller 210 may control at least some of the elements of the server in order to drive an application program stored in the memory 214. Moreover, the controller 210 may combine and operate at least two of the elements included in the server in order to drive the application program.

In an embodiment of the present disclosure, the server 200 may include a reversing engine and a CDR engine. Hereinafter, the reversing engine and the CDR engine are specifically described.

### Reversing Engine

The reversing engine is an analysis/diagnosis engine obtained by automating a reverse engineering process for a malicious non-PE file. The reversing engine is called reverse engineering. The server 200 may enter up to an assembly stage, that is, a language executable by a computer, with respect to software not having a source code through reverse engineering, and may know the principle and structure of the software. The server 200 may know a common software (e.g., MS OFFICE or PDF) structure, a malware action, a method of abusing vulnerability, etc. by using the principle and structure of the software.

For example, the reversing engine may perform a file analysis step, a static analysis step, a dynamic analysis step, and a debugging analysis step. Each of the steps is described in brief as follows.
1. File analysis step: this is a step of analyzing an appearance (e.g., properties, an author, a date created, or a file type) of a non-PE file itself. In this step, whether a non-PE file is malicious may be diagnosed based on only information of the non-PE file itself like a common vaccine program.
2. Static analysis step: this is a step of determining whether a non-PE file is normal or malicious by extracting and analyzing data within the non-PE file. In this step, whether a non-PE file is malicious may be diagnosed by extracting internal data suitably for a file structure and comparing and analyzing the extracted data, without executing the non-PE file. This step may be suitable for the extraction and analysis of a macro, and the extraction and analysis of a URL.
3. Dynamic analysis step: this is a step of determining whether a non-PE file is malicious by analyzing an act of the non-PE file while executing and monitoring the non-PE file. If this step is used, a malicious act using a normal function of the document, such as a macro, a hyperlink, or dynamic data exchange (DDE), can be easily detected.
4. Debugging analysis step: this is a step of analyzing vulnerability, exploits, etc. by executing and debugging a non-PE file. This step is suitable for detecting the vulnerability of an application program using a body, a table, a font, a picture, etc. within a document, in addition to the detection of a malicious act using a normal function of a document, such as a macro, a hyperlink, or DDE.

The reversing engine may include a debugging engine which may be used in debugging analysis. The debugging engine can diagnose vulnerability which occurs in document input, processing, and output steps in a process of reading a non-PE file in a debugging mode. In this case, the vulnerability refers to an error, a bug or the like, which occurs when an application program receives an unexpected value in a code (or logic) developed by a developer of the application program. An attacker may execute a malicious document act, such as the denial of service attributable to abnormal termination or the remote execution of a code, through the vulnerability.

A debugging engine may include a debugger. The debugger is a tool for reverse engineering, and may mean a program or process capable of setting a break point in another target program at an assembly level.

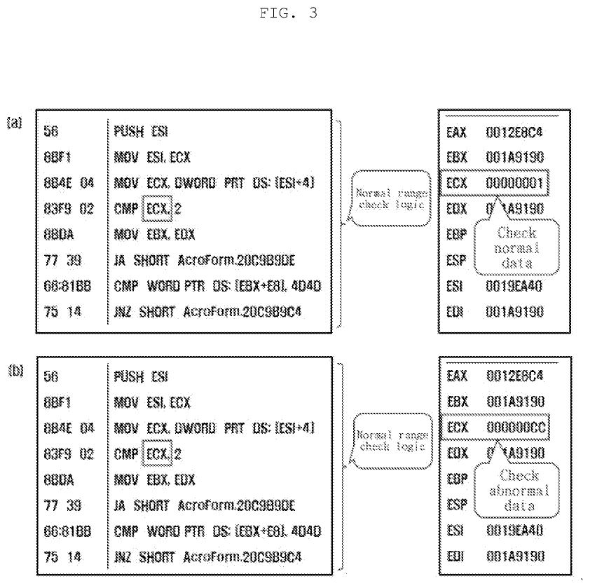

FIG. 3 is a diagram exemplifying a normal input and an abnormal input which may be applied to an embodiment of the present disclosure.

FIG. 3(a) is a diagram for describing a case in which an application program receives a normal value through a non-PE file, and exemplifies a case in which a value of an extended counter register (ECX) is normal data (00000001). FIG. 3(b) is a diagram for describing a case in which an application program receives an abnormal value through a non-PE file, and exemplifies a case in which a value of the ECX register is abnormal data (000000CC).

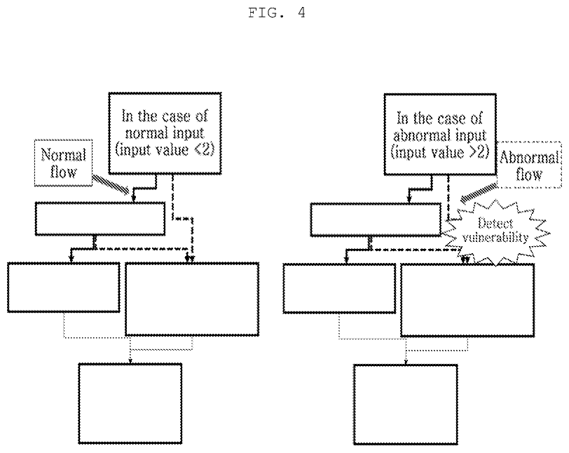

FIG. 4 is a diagram exemplifying a flow of the execution of an application program when a normal value is input and a flow of the execution of an application program when an abnormal value is input.

FIG. 4 illustrates an execution flow of an application program when the application program receives a normal value through a non-PE file and the state in which an execution flow of an application program is changed when the application program receives an abnormal value through a non-PE file.

Referring to FIG. 4, when the application program receives the normal value (e.g., when an input value does not exceed 2, that is, a normal range) through the non-PE file, an execution flow of the application program is performed according to an execution flow that has been intended by a developer.

In contrast, when the application program receives the abnormal value (e.g., when an input value exceeds 2, that is, a normal range) through the non-PE file, an execution flow of the application program is changed into an execution flow that has not been intended by a developer, so that vulnerability may occur.

The debugging engine sets a breakpoint at a specific point that is related to vulnerability by automatically debugging a document reading process. Furthermore, the debugging engine may determine whether an input value is a value that causes vulnerability by checking a specific value (i.e., a value stored in a register or memory) related to the input value, and may diagnose whether a non-PE file is malicious.

More specifically, after confirming the type of non-PE file, the debugging engine may start debugging by executing an application program for reading the non-PE file. In the process of reading the non-PE file, when a module related to a document act is loaded, the debugging engine identifies whether the loaded module is a target analysis module. If the loaded module is the analysis target as a result of the identification, the debugging engine may set a breakpoint at a designated address.

For example, a malicious non-PE file may have branch points that branch to a flow in which an application program is terminated or no malicious act occurs, if a specific condition, such as the version of the application program or an operating system environment, is not satisfied. The server 200 may set a breakpoint at a branch point that has been previously analyzed by an analyst and that has such a possibility.

Furthermore, the server 200 may set conditions that induce an execution flow of an application program to a flow in which the application program is continuously executed without being terminated or a malicious act may occur, in association with a corresponding branch point.

If a process of an application program is stopped at a corresponding breakpoint during the execution of the process, the server 200 may perform a step of storing the results of detection in an analysis result report after detecting whether vulnerability occurs by using detection logic.

An automation reversing engine included in the server 200 can diagnose and block a malicious non-PE file through a diagnosis algorithm researched and developed by an analyst by analyzing the aforementioned steps while automatically performing the aforementioned steps.

### Contents Disarm and Reconstruction (CDR) Engine

The CDR engine provides a CDR service. The CDR service is a solution for generating a new file by decomposing a non-PE file, removing a malicious file or an unnecessary file, and making content identical with the original as much as possible.

That is, CDR means a service for generating a safe document by disarming and reconstructing content within a document and providing the safe document to a customer. In this case, a disarming target file may be all non-PE files. Example of the non-PE files may include an MS Word file, an Excel file, a PowerPoint file, a Hangul file, and a PDF file. Disarming target content may be active content. Examples of the active content may include a macro, a hyperlink, and object linking and embedding (OLE). According to an embodiment, the CDR engine may generate a disarming result report by performing disarming on content within a non-PE file.

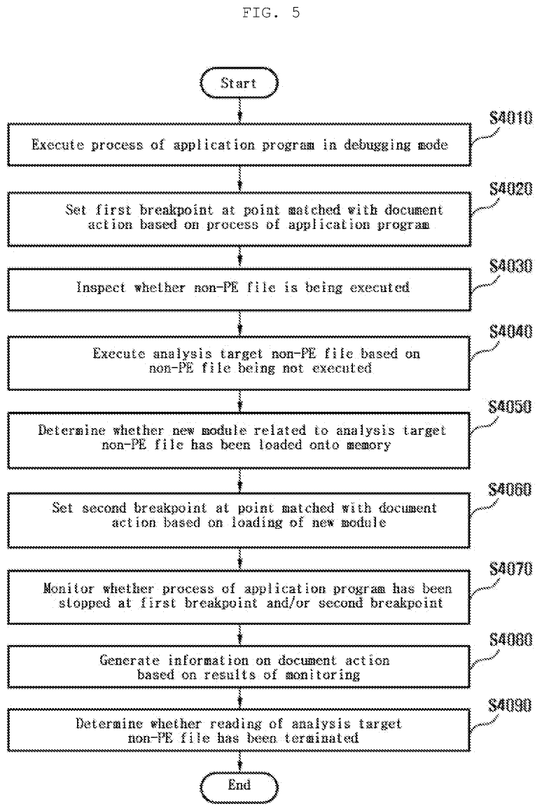

Referring back to FIG. 2, the result reading unit 220 generates the results of the reading of a disarming file, based on an analysis result report generated by the reversing engine and a disarming result report generated by the CDR engine. Furthermore, the result reading unit 220 permits or blocks the disarming file based on the results of the reading. In this case, the disarming file means a file on which the execution of disarming has been completed. The results of the reading of the disarming file and/or information on whether the disarming file will be blocked may be transmitted to the electronic device 100 of a user, and may be output through the output unit 150 of the electronic device 100. FIG. 5 is a flowchart exemplifying a method of determining a document act which may be applied to an embodiment of the present disclosure.

Referring to FIG. 5, the server 200 may include a non-PE file and an application program (e.g., MS Office or Hancom Office) for executing a non-PE file.

The server 200 executes a process of the application program in a debugging mode (54010). For example, the server 200 may execute a document process for opening an analysis target non-PE file of the application program in the debugging mode (DEBUG_ONLY_THIS_PROCESS) by using a CreateProcess API. Accordingly, the server 200 may receive a debug event of the process of the application program.

More specifically, the server 200 may execute the process of the application program by assigning a flag “DEBUG_ONLY_THIS_PROCESS” by using the CreateProcess API.

The server 200 sets a first breakpoint at a point that is matched with a document act, based on the process of the application program (S4020). For example, the server 200 may set a breakpoint by changing, into “0xCC”, an operation (OP) code related to the process of the application program loaded onto the memory 214. The OP code means an instruction code, and may be a code in which the contents of a task that needs to be actually performed by a CPU are written. To this end, the server 200 may change the memory 214 by using WriteProcessMemory.

Information on a document act and a point matched with the document act may be previously set in the server 200. For example, the server 200 may set a breakpoint by using a WriteProcessMemory API based on an action matching breakpoint table that has been previously defined.

The server 200 inspects whether a non-PE file is being executed (54030). More specifically, after setting the breakpoint, the server 200 checks whether other non-PE files of which analysis has been requested have been read. A required module is loaded onto the memory 214 in a process of an application program, based on a function required for a non-PE file. Accordingly, the application program needs to have a state in which other non-PE files have not been read, in terms of securing the reliability of a determination of a document act for a non-PE file, that is, a target. For example, if a malicious non-PE file has been read, the reliability of the results of a determination of the document act may be low.

The server 200 executes an analysis target non-PE file based on other non-PE files being not executed (54040). More specifically, the server 200 reads a non-PE file of which analysis has been requested by a user by using a process of an application program (e.g., EXCEL, WORD, or PPT) suitable for a corresponding format. For example, the server 200 may read a sample.ppt file by using MS PowerPoint.

The server 200 determines whether a new module related to the analysis target non-PE file has been loaded onto the memory 214 (S4050). When the analysis target non-PE file is executed by the process of the application program, the server 200 checks whether the new module has been loaded.

For example, in the debugging mode, when a debugging event occurs in the process of the application program, the server 200 may receive the event. When a LOAD DLL event occurs based on the debugging event, the server 200 may determine the LOAD DLL event as a new module (e.g., DLL memory mounting). More specifically, when a “LOAD_DLL_DEBUG_EVENT” event occurs, the server 200 may determine that a new module has been loaded onto the memory 214.

For example, the server 200 may newly load, onto the memory 214, a module suitable for a process function of an application program in order to use a function (e.g., a macro function or an ActiveX function) necessary for an analysis target non-PE file.

The server 200 sets a second breakpoint at a point matched with the document act, based on the loading of the new module (S4060). If it is determined that a new module has not been loaded, the server 200 does not set a second breakpoint.

The server 200 monitors whether a process of the application program has been stopped at the first breakpoint and/or the second breakpoint (S4070). For example, the server 200 may identify whether a process of the application program has been stopped at the breakpoint and the right to control the process has been handed over to a debugger. The debugger that has taken over the right to control the process may identify at which breakpoint has a process of the application program been stopped.

The server 200 generates information on a document act that is matched with the first breakpoint and/or the second breakpoint, based on the results of the monitoring (S4080). For example, the server 200 may check an address value of the breakpoint. Thereafter, the server 200 may generate information on a document act that is matched with an address value of the breakpoint, based on the document act and information on a point with which the document act is matched, and may store the information in an analysis result report.

Table 1 is an example of a document act that is matched with a stored address value of a breakpoint.

TABLE 1

| ADDRESS OF BREAKPOINT | DOCUMENT ACTION |
|---|---|
| 0x12345678 | Execute ActiveX in a document |

In addition, the server 200 may perform an additional action in order to obtain a document act.

After step S4080, the server 200 determines whether the reading of the analysis target non-PE file has been terminated (S4090). For example, the server 200 may determine whether the reading of the analysis target non-PE file has been terminated in a way, such as whether a preset time has elapsed, whether a message box (Alert) appears, or if a break point has not been passed for a given time.

If the reading of the analysis target non-PE file has not been terminated, the server 200 persistently monitors whether the process of the application program has been stopped at the breakpoint. Accordingly, the server 200 may wait so that the document act is sufficiently revealed.

Thereafter, the server 200 may transmit, to a terminal, the stored information on the document act. To this end, the terminal may communicate with the server 200, and may include a management application program capable of controlling an operation of the server. The terminal may provide a user with the information on the document act through the management application program.

The existing APT solution extracts a document act based on a change in the sandbox after the document act is revealed. In this case, the time taken for analysis is long because the sandbox has to wait until the document act is revealed. Furthermore, an analysis speed for the document act is slower than that of this specification because the last part (e.g., after the sandbox is changed) is finally checked.

Furthermore, the server 200 of this specification may start the analysis of a document act from timing at which a process of an application program is executed in a step prior to a change in the sandbox.

Furthermore, an analysis speed (action extraction) of a document act is higher than that of the existing APT solution because a change in the document act is checked from an assembly level (e.g., a CPU instruction processing step).

Furthermore, it is difficult for the existing APT solution to know end timing because the sandbox has to wait until the document act is revealed. However, in this specification, the server can rapidly analyze a document act because the server can approximately determine end timing of the document act.

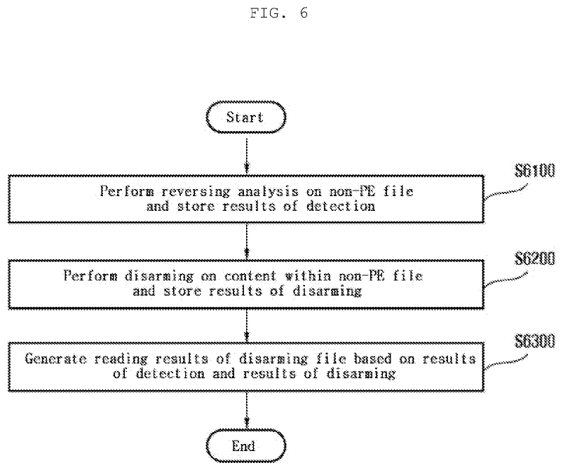

FIG. 6 is a flowchart exemplifying a method of blocking a non-PE file which may be applied to an embodiment of the present disclosure.

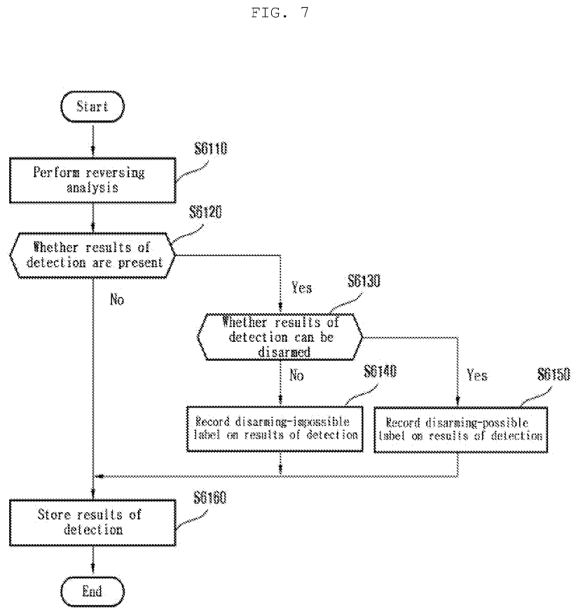

The reversing engine of the server 200 performs reversing analysis on an input non-PE file, and stores the results of the detection of vulnerability and/or malicious active content (S6100). The results of the detection are provided to the result reading unit 220. Step S6100 will be more specifically described with reference to FIGS. 7 to 9.

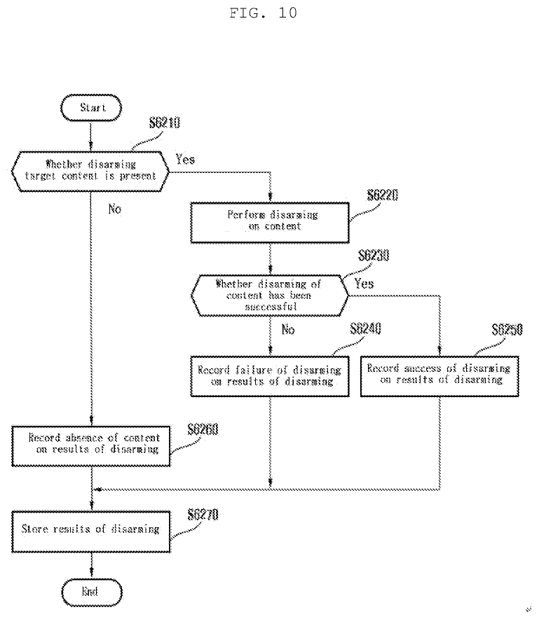

The CDR engine of the server 200 performs disarming on content within the input non-PE file, and stores the results of the disarming (S6200). In this case, step S6200 does not need to be essentially performed after step S6100, and step S6200 and step S6100 may be simultaneously performed. The results of the disarming are provided to the result reading unit 220. Step S6200 will be more specifically described with reference to FIGS. 10 to 12.

The result reading unit 220 of the server 200 generates the final reading results of a disarming file based on the results of the detection provided by the reversing engine and the results of the disarming provided by the CDR engine (S6300). Specifically, the reading results may include one or more of the type of input non-PE file, contents (e.g., vulnerability, a macro, a hyperlink, or JavaScript) detected by the reversing engine, whether the detected contents may be disarmed by the CDR engine, whether the detected contents has been disarmed by the CDR engine, and whether a disarming file is safe. The type and/or number of information to be included in the reading results, among the pieces of exemplified information, may be implemented to be able to be changed by a user. Furthermore, the generated reading results may be provided to a terminal of a user, and may be output in the form of a voice signal and/or an image signal through the output unit of the terminal.

FIG. 7 is a flowchart specifically illustrating step S6100 of storing the results of the detection in FIG. 6.

The reversing engine performs reversing analysis on the input non-PE file (S6110). Step S6110 may be understood as being the method of determining a document act illustrated in FIG. 5.

Thereafter, the reversing engine determines whether results detected by the reversing analysis are present (S6120). For example, the reversing engine determines whether vulnerability or malicious active content detected in the non-PE file is present.

When the results of the detection are present as a result of the determination in S6120, the reversing engine determines whether the results of the detection may be disarmed by the CDR engine of the server 200 (S6130). The determination may be performed based on the type of CDR engine. The reason for this is that disarming coverage is different depending on the type of CDR engine. In this case, the disarming coverage may be understood as a concept which includes one or more of a file that may be disarmed and content that may be disarmed. Specifically, if the existing CDR engine is taken as an example, in the case of MS Office 2003 version and MS Office 2007 version or higher, content called JavaScript cannot be disarmed, but content, such as a macro, Flash, OLE, ActiveX, Embedded Document, Hyperlink, and Attachments, can be disarmed. Furthermore, in the case of Arae-A Hangul, a macro and a hyperlink cannot be disarmed, but the remaining contents can be disarmed. Furthermore, in the case of Adobe Acrobat, a macro, an OLE object, and ActiveX cannot be disarmed, but the remaining contents can be disarmed. Information on the disarming coverage of the CDR engine may be previously stored in the server 200, but the determination in step S6130 may be performed based on the stored information.

If the results of the detection cannot be disarmed by the CDR engine as a result of the determination in step S6130, a disarming-impossible label is recorded on the results of the detection (S6140).

If the results of the detection can be disarmed by the CDR engine as a result of the determination in step S6130, a disarming-possible label is recorded on the results of the detection (S6150).

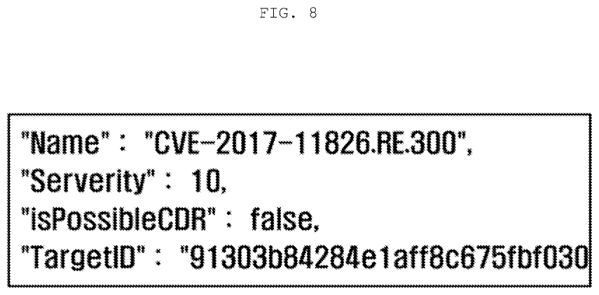

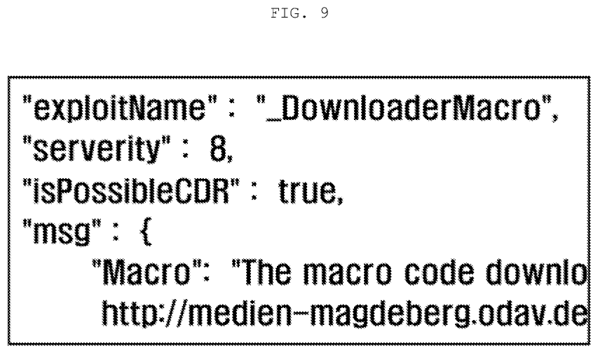

When the recording of the label is completed, the results of the detection are stored (S6160). The results of the detection may have an XML format, for example, but the present disclosure is not limited to the exemplified format. In this case, the results of the detection by the reversing engine are described with reference to FIGS. 8 and 9.

FIG. 8 is a diagram illustrating an example of the results of detection by the reversing engine.

Referring to FIG. 8, it may be seen that the results of detection have an XML format. Furthermore, it may be seen that “CVE-2017-11826.RE.300” has been recorded on an item “Name” and a value “false” has been recorded on an item “isPossibe1CDR”. This means that body vulnerability has been detected by the debugging engine during the execution of reversing analysis and the detected body vulnerability cannot be disarmed by the CDR engine.

FIG. 9 is a diagram illustrating another example of the results of detection by the reversing engine.

Referring to FIG. 9, it may be seen that vulnerability detection results have an XML format. Furthermore, “_DownloaderMacro” has been recorded on an item “exploitName” and a value “true” has been recorded on an item “isPossibleCDR.” This means that a malicious macro has been detected by the debugging engine during the execution of reversing analysis and the detected malicious macro can be disarmed by the CDR engine.

FIG. 10 is a flowchart specifically illustrating step S6200 of generating the results of the disarming in FIG. 6.

The CDR engine determines whether disarming target content is present within the input non-PE file (S6210). The disarming target content may be active content, such as a macro, a hyperlink, or OLE.

When the disarming target content is present within the non-PE file as a result of the determination in S6210, the CDR engine performs disarming on the disarming target content (S6220). The disarming of the content is a known technology, and a detailed description thereof is omitted.

Thereafter, the CDR engine determines whether the disarming of the content has been successful (S6230).

When the disarming of the content fails as a result of the determination in S6230, the CDR engine records a failure of the disarming on the results of the disarming (S6240).

When the disarming of the content is succeeded as a result of the determination in S6230, the CDR engine records a success of the disarming on the results of the disarming (56250).

When disarming target content is not present within the non-PE file as a result of the determination in step S6210, the CDR engine records the absence of disarming target content on the results of the disarming (S6260).

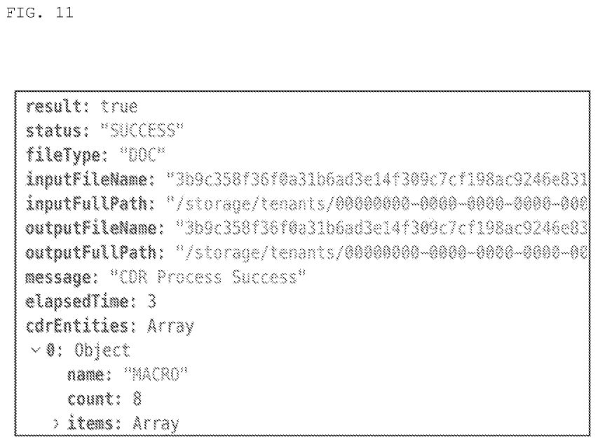

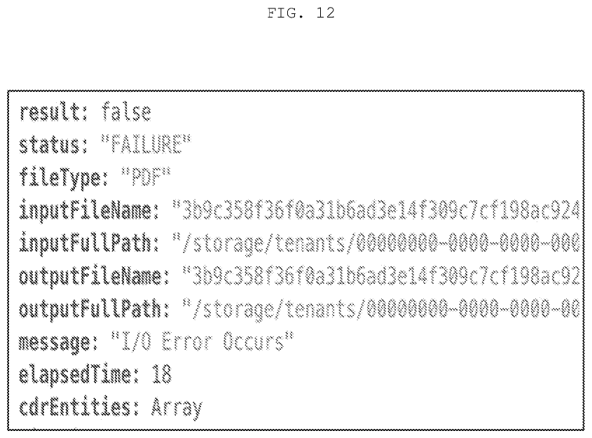

When the recording of the results of the disarming is completed, the CRD engine stores the results of the disarming (56270). In this case, the results of the disarming by the CDR engine are described with reference to FIGS. 11 and 12.

FIG. 11 is a diagram illustrating an example of the results of the disarming by the CDR engine.

Referring to FIG. 11, a value “true” has been recorded on an item “result. This means that a non-PE file is disarmed. Furthermore, a value “SUCCESS” has been recorded on an item “status.” This means that the disarming of disarming target content within a non-PE file has been successful. Furthermore, “CDR Process Success” has been recorded on an item “message.” This means that disarming has been successfully performed by the CDR engine.

That is, if disarming target content is present within a non-PE file and the disarming of the disarming target content is successful, the value “SUCCESS” is recorded on the item “status.” Furthermore, since the disarming of the disarming target content has been successful, the non-PE file is also determined to be disarmed, and the value “true” is recorded on the item “result.”

If disarming target content is not present within the non-PE file, a value “NO DETECTION” is recorded on the item “status.” Furthermore, the non-PE file is also determined to be disarmed, and thus the value “true” is recorded on the item “result”.

The results of the disarming may further include items “fileType”, “inputFileName”, “inputFullPath”, “outputFileName”, “outputFullPath”, “elapsedTime”, “cdrEntities” in addition to the items “result”, “status”, and “message.” The item “fileType” is a part on which the type of non-PE file is recorded. The item “inputFileName” and the item “inputFullPath” are parts on which the name of the non-PE file and the storage path of the non-PE file are recorded, respectively. The item “outputFileName” and the item “outputFullPath” are parts on which the name of a disarming file and the storage path of the disarming file are recorded, respectively.

FIG. 12 is a diagram illustrating another example of the results of the disarming by the CDR engine.

Referring to FIG. 12, a value “false” has been recorded on an item “result.” This means that a non-PE file is not disarmed. Furthermore, a value “FAILURE” has been recorded on an item “status.” This means that the disarming of disarming target content within the non-PE file has failed. Furthermore, “I/O Error Occurs” has been recorded on an item “message. This means that a disarming failure error may occur due to an input and output error for a file.

That is, if disarming target content is present within the non-PE file and the disarming of the disarming target content has failed, the value “FAILURE” is recorded on the item “status.” Furthermore, since the disarming of the disarming target content has failed, the value “false” is recorded on the item “result” because the non-PE file is determined to be not disarmed.

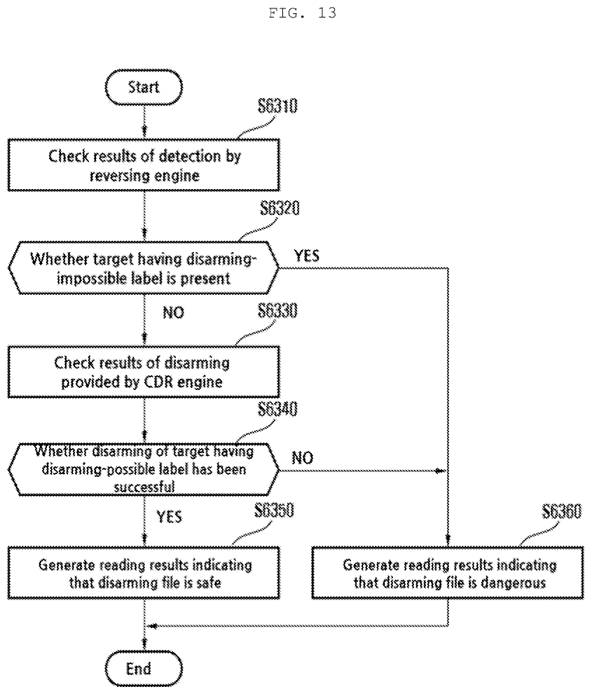

FIG. 13 is a flowchart specifically illustrating step S6300 of generating the results of the reading in FIG. 6.

The result reading unit 220 determines whether a target (e.g., vulnerability or malicious active content) having a disarming-impossible label is present (S6320) by checking the results of the detection provided by the reversing engine (S6310).

When the target having the disarming-impossible label is not present as a result of the determination in S6320, the result reading unit 220 determines that a target having a disarming-possible label is present. Furthermore, the result reading unit 220 determines whether the disarming of the target having the disarming-possible label has been successful (S6340) by checking the results of the disarming provided by the CDR engine (S6330).

If the disarming of the target having the disarming-possible label has been successful as a result of the determination in S6340, the result reading unit 220 generates reading results indicating that the disarming file is safe (S6350).

If the disarming of the target having the disarming-possible label has failed as a result of the determination in S6340, the result reading unit 220 generates reading results indicating that the disarming file is dangerous (S6380).

Thereafter, the result reading unit 220 may permit or block the disarming file based on the reading results. Specifically, if the disarming file has been read as being safe, the result reading unit 220 permits the disarming file. In contrast, if the disarming file has been read as being dangerous, the result reading unit 220 blocks the disarming file.

In addition, the result reading unit 220 may provide the reading results of the disarming file to a terminal of a user so that the reading results are output through the output unit.

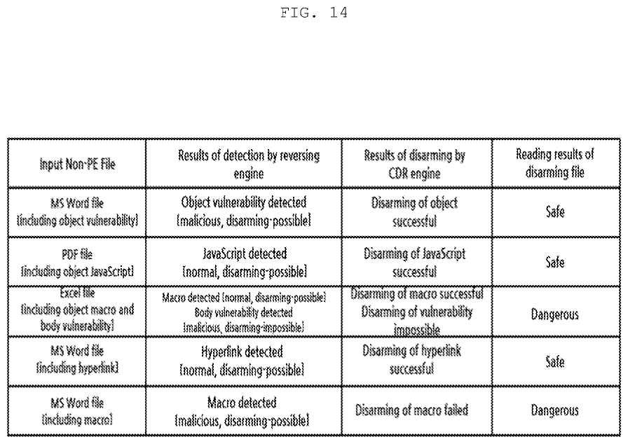

FIG. 14 is a diagram exemplifying a reading result screen displayed through a terminal.

Referring to FIG. 14, the reading result screen may include the type of input non-PE file, the results of detection by the reversing engine, the results of disarming by the CDR engine, and the final reading results of a disarming file.

The results of detection by the reversing engine may include information on detected contents and whether the detected contents are malicious. Example of the detected contents may include object vulnerability, body vulnerability, a macro, a hyperlink, OLE, JavaScript, etc.

The results of disarming by the CDR engine may include information on a disarming target and whether the disarming of the disarming target is successful.

Referring to FIG. 14, if an MS Word file including object vulnerability has been input as a non-PE file, it may be seen that object vulnerability is detected by the reversing engine. Furthermore, it may be seen that the detected object vulnerability has been analyzed as being malicious and a disarming-possible label meaning that the detected object vulnerability can be disarmed by the CDR engine has been assigned to the detected object vulnerability. Furthermore, it may be seen that in relation to the object vulnerability, the disarming of the object by the CDR engine has been actually successful. As the results of a comprehensive determination of such results of the detection by the reversing engine and such results of the disarming by the CDR engine, it may be seen that a disarming file output by the CDR engine has been read as being safe.

If a PDF file including JavaScript is input as a non-PE file, it may be seen that JavaScript has been detected by the reversing engine. Furthermore, it may be seen that the detected JavaScript has been analyzed as being normal not malicious and a disarming-possible label meaning that the detected JavaScript can be disarmed by the CDR engine has been assigned to the detected JavaScript. In this case, the results of analysis indicating that the detected JavaScript is normal may be results obtained because it is difficult for the reversing engine to detect a malicious act using JavaScript. Accordingly, if the disarming-possible label is assigned to the detected JavaScript, the results of the detection are stored, and the stored detection contents and the results of the disarming by the CDR engine are compared, more accurate reading results for a disarming file output by the CDR engine may be obtained. Since the disarming of the detected JavaScript has been actually successful by the CDR engine, it may be seen that the disarming file output by the CDR engine has been read as being safe as the results of a comprehensive determination of the results of the detection by the reversing engine and the results of the disarming by the CDR engine.

If an Excel file including a macro and body vulnerability has been input as a non-PE file, it may be seen that the macro and the body vulnerability have been detected by the reversing engine. In this case, it may be seen that the detected macro has been analyzed as being normal not malicious and a disarming-possible label has been assigned to the detected macro. In this case, the results of the analysis indicating that the detected macro is normal may be results obtained because it is difficult for the reversing engine to detect a malicious act using the macro. Accordingly, if the disarming-possible label is assigned to the detected macro, the results of the detection are stored, and the stored detection contents and the results of the disarming by the CDR engine are compared, more accurate reading results of a disarming file output by the CDR engine may be obtained. It may be seen that body vulnerability detected in the non-PE file has been analyzed as being malicious and a disarming-impossible label has been assigned to the body vulnerability. Since the CDR engine cannot disarm the detected body vulnerability, it may be seen that the disarming file output by the CDR engine has been read as being dangerous although the disarming of the detected macro is successful.

If an MS Word file including a hyperlink has been input as a non-PE file, it may be seen that the hyperlink has been detected by the reversing engine. Furthermore, it may be seen that the detected hyperlink has been analyzed as being normal not malicious and a disarming-possible label has been assigned to the detected hyperlink. In this case, the results of the analysis indicating that the detected hyperlink is normal may be results obtained because it is difficult for the reversing engine to detect a malicious act using the hyperlink. Accordingly, if the disarming-possible label is assigned to the detected hyperlink, the results of the detection are stored, and the stored detection contents and the results of the disarming by the CDR engine are compared, more accurate reading results of a disarming file output by the CDR engine may be obtained. It may be seen that the disarming file output by the CDR engine has been read as being actually safe because the disarming of the hyperlink by the CDR engine is successful.

If an MS Word file including a macro has been input as a non-PE file, it may be seen that the macro has been detected by the reversing engine. Furthermore, it may be seen that the detected macro has been analyzed as being malicious and a disarming-possible label has been assigned to the detected macro. However, it may be seen that the CDR engine has failed in the disarming of the detected macro. As the results of a comprehensive determination of such results of the detection by the reversing engine and such results of the disarming by the CDR engine, it may be seen that a disarming file output by the CDR engine has been read as being dangerous.

In FIG. 14, the disarming file determined to be safe is permitted, and the disarming file determined to be dangerous is blocked.

According to the method of blocking a non-PE file, a security blank which may occur in the CDR engine can be solved.

The method of blocking a non-PE file according to an embodiment of the present disclosure has been described above. According to the method of blocking a non-PE file, a security blank which may occur when only the reversing engine is used and a security blank which may occur when only the CDR engine is used can be supplemented by using both the reversing engine and the CDR engine.

The disclosed embodiments may be implemented in the form of a recording medium that stores an instruction which may be executed by a computer. The instruction may be stored in the form of a program code. When the instruction is executed by the processor, the instruction may generate a program module and perform an operation of the disclosed embodiments. The recording medium may be implemented as a computer-readable recording medium.

The computer-readable recording medium includes all types of recording media in which an instruction which may be interpreted by a computer has been stored. For example, the computer-readable recording medium may include read only memory (ROM), random access memory (RAM), a magnetic tape, a magnetic disk, flash memory, and an optical data storage device.

Furthermore, the computer-readable recording medium may be provided in the form of a non-transitory storage medium. In this case, the “non-transitory storage medium” is a tangible device, and means that a signal (e.g., electromagnetic waves) is not included. The term does not discriminate between a case where data is semipermanently stored in a storage medium and a case in which data is temporarily stored in a storage medium. For example, the “non-transitory storage medium” may include a buffer in which data is temporarily stored.

According to an embodiment, the method according to various embodiments disclosed in this document may be included in a computer program product and provided. The computer program product may be traded as a product between a seller and a purchaser. The computer program product may be distributed in the form of a machine-readable storage medium (e.g., a compact disc read only memory (CD-ROM)) or may be distributed through an app store (e.g., PlayStore™) or directly between two user devices (e.g., smartphones) or online (e.g., download or upload). In the case of the online distribution, at least some of the computer program products (e.g., downloadable app) may be at least temporarily stored or provisionally generated in a machine-readable storage medium, such as the memory of the server of a manufacturer, the server of an app store or a relay server.

The embodiments of the present disclosure have been described above with reference to the accompanying drawings. A person having ordinary knowledge in the art to which the present disclosure pertains may understand that the present disclosure may be implemented in other detailed forms without changing the technical spirit or essential characteristics of the present disclosure. Accordingly, it is to be understood that the aforementioned embodiments are only illustrative, but are not limitative in all aspects

### INDUSTRIAL APPLICABILITY

The method and apparatus for blocking a malicious non-PE file using the reversing engine and the CDR engine may be applied to a cyber security field.

1. A method of blocking, by a server, a malicious non-portable executable (non-PE) file using a reversing engine and a contents disarm and reconstruction (CDR) engine, the method comprising:
detecting at least one of vulnerability and content within an analysis target non-PE file by performing reversing analysis on the analysis target non-PE file and storing results of the detection;
performing disarming on the content within the analysis target non-PE file and storing results of the disarming;
generating results of a reading of a disarming file obtained by performing the disarming, based on the results of the detection and the results of the disarming; and
blocking the disarming file based on the results of the reading.

2. The method of claim 1, wherein the storing of the results of the detection comprises:
recording information on whether the detected vulnerability or the detected content is malicious;
recording a disarming-possible label for the detected vulnerability or the detected content when the detected vulnerability or the detected content is included in disarming coverage of the CDR engine; and
recording a disarming-impossible label for the detected vulnerability or the detected content when the detected vulnerability or the detected content is not included in the disarming coverage of the CDR engine.

3. The method of claim 2, wherein the generating of the results of the reading comprises reading the disarming file as being dangerous when vulnerability or content having the disarming-impossible label is present as a result of checking the results of the detection.

4. The method of claim 2, wherein the generating of the results of the reading comprises reading the disarming file as being safe, when vulnerability or content having the disarming-possible label is present as a result of checking the results of the detection and the disarming of the vulnerability or content having the disarming-possible label is successful.

5. The method of claim 1, further comprising transmitting the results of the reading of the disarming file to a terminal.

6. The method of claim 1, wherein the reversing analysis for the analysis target non-PE file comprises:
executing a process of an application program related to the analysis target non-PE file in a debugging mode;
setting a first breakpoint at a point matched with a document act based on a process of the application program;
executing the analysis target non-PE file;
performing first monitoring on whether the process of the application program has been stopped at the first breakpoint; and
generating document act information of the analysis target non-PE file based on a result of the first monitoring.

7. A server which performs a method of blocking a malicious non-portable executable (non-PE) file using a reversing engine and a contents disarm and reconstruction (CDR) engine, the server comprising:
a communication unit;
a memory comprising the reversing engine and the CDR engine; and
a processor,
wherein the processor is configured to functionally control the communication unit and the memory, configured to detect at least one of vulnerability and content within an analysis target non-PE file by performing reversing analysis on the analysis target non-PE file and store results of the detection by using the reversing engine, and configured to perform disarming on the content within the analysis target non-PE file and store results of the disarming by using the CDR engine; and
a result reading unit configured to generate results of a reading of a disarming file obtained by performing the disarming, based on the results of the detection and the results of the disarming, and block the disarming file based on the results of the reading.
